(19) United States
(12) Patent Application Publication
(10) Pub. No.: US 2025/0062476 A1
(43) Pub. Date: Feb. 20, 2025

(54) HIGH VOLTAGE BATTERY SYSTEM AND METHOD FOR ISOLATING FAULTY BATTERY MODULE

(71) Applicant: FCA US LLC, Auburn Hills, MI (US)

(72) Inventors: Uday Mahakali, Novi, MI (US); Shreekanth Surapaneni, Oakland, MI (US)

(21) Appl. No.: 18/452,034

(22) Filed: Aug. 18, 2023

(51) Int. Cl. H01M 50/264; H01M 10/48; H01M 50/244; H01M 50/249

(52) U.S. Cl. CPC H01M 50/264; H01M 10/486; H01M 50/244; H01M 50/249; H01M 2220/20

(57) ABSTRACT

A battery system for an electrified vehicle includes a battery pack, a fastening assembly, a decoupler, at least one sensor assembly and a controller. The battery pack includes a battery module assembly having at least a first battery module and a second battery module. The fastening assembly includes a fastening set associated with each battery module. The decoupler is configured to initiate decoupling of a selected battery module from the battery pack. The sensor senses a thermal event at a faulty battery module and communicates a thermal event signal in response to the sensing. The controller receives the thermal event signal and, responsive to the thermal event signal, communicates a decoupling signal to the decoupler to decouple the faulty battery module from the battery pack.

### FIELD

The present application generally relates to electrified vehicles and, more particularly, to a high voltage battery system and related method that isolates a faulty battery module to mitigate a thermal runaway event.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor.

The high voltage battery system generally includes battery cells arranged in modules. In rare instances, a single faulty battery cell can lead to a potential thermal runaway event where a fault in a single battery cell can spread to one or more modules. In such instances, a thermal event can lead to damage in more than one module or ultimately the entire battery system. Accordingly, while such high voltage battery systems do work well for their intended purpose, there exists an opportunity for improvement in the relevant art.

### SUMMARY

According to one example aspect of the invention, a battery system for an electrified vehicle includes a battery pack, a fastening assembly, a decoupler, at least one sensor and a controller. The battery pack includes a battery module assembly having at least a first battery module and a second battery module. The fastening assembly includes a fastening set associated with each battery module. The decoupler is configured to initiate decoupling of a selected battery module from the battery pack. The sensor senses a thermal event at a faulty battery module and communicates a thermal event signal in response to the sensing. The controller receives the thermal event signal and, responsive to the thermal event signal, communicates a decoupling signal to the decoupler to decouple the faulty battery module from the battery pack.

In some implementations, the fastening set associated with each battery module comprises at least one nut and threaded fastener. The decoupler is configured to send an electric pulse to the fastening set causing the fastening set to fail.

According to another example aspect of the invention, the fastening set further comprises a first plurality of fasteners on a first side of the battery module. In additional examples, the fastening set further includes a second plurality of fasteners on a second side of the battery module.

In some implementations, the fastening set comprises an electromagnetic fastener that couples the respective battery modules to the battery pack. The decoupler sends an electromagnetic signal that demagnetizes the identified fastening set.

In other implementations, the sensors comprise a sensor associated with each battery module of the battery module assembly.

A method of isolating a faulty battery module from a battery pack in an electrified vehicle is provided. Thermal sensors that sense a thermal event at a faulty battery module of a battery pack are monitored at a controller. The controller receives a thermal signal from the thermal sensors indicative of a thermal event at the faulty battery module. The controller, in response to the thermal signal, sends a decoupling signal to a decoupler that decouples the faulty battery module from the battery pack.

In additional arrangements, sending the decoupling signal includes sending a pulse to a fastening set associated with the faulty battery module, the pulse causing the fastening set to fail resulting in the faulty battery module to drop away from the battery pack.

According to another example aspect of the invention, the fastening set further comprises a first plurality of fasteners on a first side of the battery module. In additional examples, the fastening set further includes a second plurality of fasteners on a second side of the battery module.

In some implementations, the fastener set includes at least one nut and bolt.

In other implementations, sensing the decoupling signal includes sending an electromagnetic signal that demagnetizes the fastening set. In examples, the battery pack comprises a plurality of battery modules and wherein monitoring thermal sensors that sense a thermal event at a faulty battery module of the battery pack comprises monitoring a thermal sensor associated with each battery module of the plurality of battery modules in the battery pack.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery system including a battery pack assembly according to the principles of the present application;

FIG. 2 is front perspective view of an exemplary battery system of FIG. 1 according to the principles of the present application;

FIG. 3 is a schematic illustration of an exemplary battery pack of the battery system of FIG. 2 showing an example module assembly arrangement according to the principles of the present application;

FIG. 4 is a schematic illustration of the exemplary battery pack of FIG. 3 showing fasteners disengaging an identified faulty battery module according to the principles of the present application;

FIG. 5 is a schematic illustration of the exemplary battery pack of FIG. 4 subsequent to separation from the faulty battery module identified in FIG. 4 according to principles of the present application; and

FIG. 6 is a flow chart illustrating a method of decoupling a faulty battery module according to principles of the present application.

### DESCRIPTION

As previously discussed, there exists an opportunity for improvement in the art of electrified vehicles having high-voltage batteries. As is known, a high voltage battery pack consists of a collection of a large number of cells that are arranged in series or parallel (or a combination of both) designed to hold electric charge and deliver electric power to an electric motor (or motors) in an electrified vehicle. This collection of cells, electrical wiring, electronics and thermal systems are all enclosed in an outer casing to form the battery pack. A battery cell is a fundamental unit in a high voltage battery pack and is a sub-unit of a battery module. A cell is made up of chemicals and is capable of storing and discharging electricity. A battery module is a sub-unit of a high voltage battery pack. It is made up by electrically connecting two or more cells in series or parallel.

Thermal runaway events in most cases initiate from a single faulty battery cell inside one battery module of a plurality of battery modules that make up the battery pack. Thermal runaway occurs when a faulty or damaged cell in a particular battery module leads to a chain event where some or all of the battery pack (multiple battery modules) are damaged. In some cases, the damage can further extend to additional portions of the electrified vehicle. For example, in some instances, a faulty cell in a high-voltage battery can overheat, get damaged or be miss-used causing a thermal event. In such scenarios, it is desirable to isolate and decouple the faulty battery module from the remainder of the battery pack and move the vehicle away from the high-voltage battery.

The present disclosure provides a high-voltage battery system and method to isolate a faulty battery module as soon as a thermal runaway event is predicted by a controller to minimize the potential of a thermal event being transferred to nearby battery modules. When a thermal event is detected in a particular battery module, a coupling assembly holding the identified battery module in the battery pack is released causing the failed module to be decoupled from the rest of the battery pack and released onto the ground. While the following discussion is directed toward isolating a single battery module, the same principles may be applied when identifying more than one battery module failing and releasing multiple faulty battery modules from the battery pack. The electrified vehicle can still draw power from the remainder of the battery pack for a brief period so as to propel the electrified vehicle a distance away from the failed and released battery module.

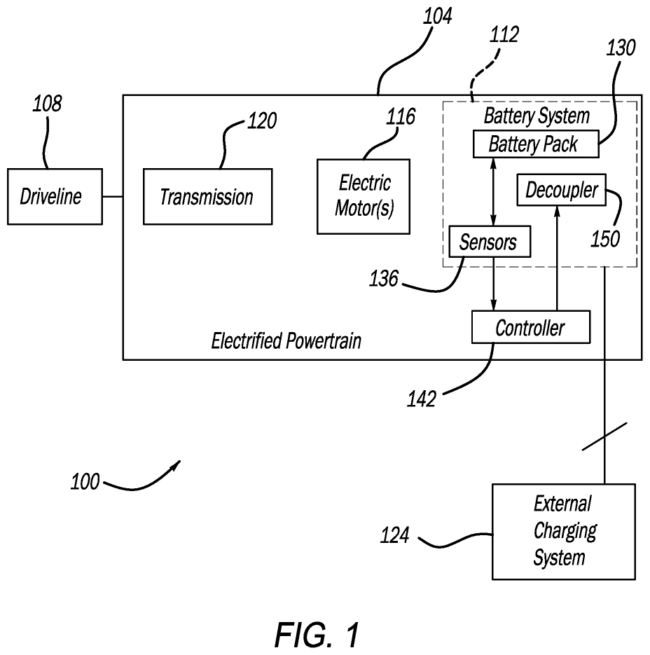

Referring now to FIG. 1, a functional block diagram of an example electrified vehicle 100 (also referred to herein as “vehicle 100”) according to the principles of the present application is illustrated. The vehicle 100 includes an electrified powertrain 104 configured to generate and transfer drive torque to a driveline 108 of the vehicle 100 for propulsion. The electrified powertrain 104 generally comprises a high voltage battery system 112 (also referred to herein as “battery system 112”), one or more electric motors 116, and a transmission 120. The battery system 112 is selectively connectable (e.g., by the driver) to an external charging system 124 (also referred to herein as “charger 124”) for charging of the battery system 112.

The battery system 112 includes at least one battery pack 130 housed within a battery casing 132. Sensors 136 communicate signals to a controller 142 based on operating conditions sensed at the battery pack 130. As will become appreciated from the following discussion, the controller 142 communicates signals to the decoupler 150, based on the signals received from the sensors 136, to decouple a faulty battery module from the battery system 112 to prevent a runaway thermal event.

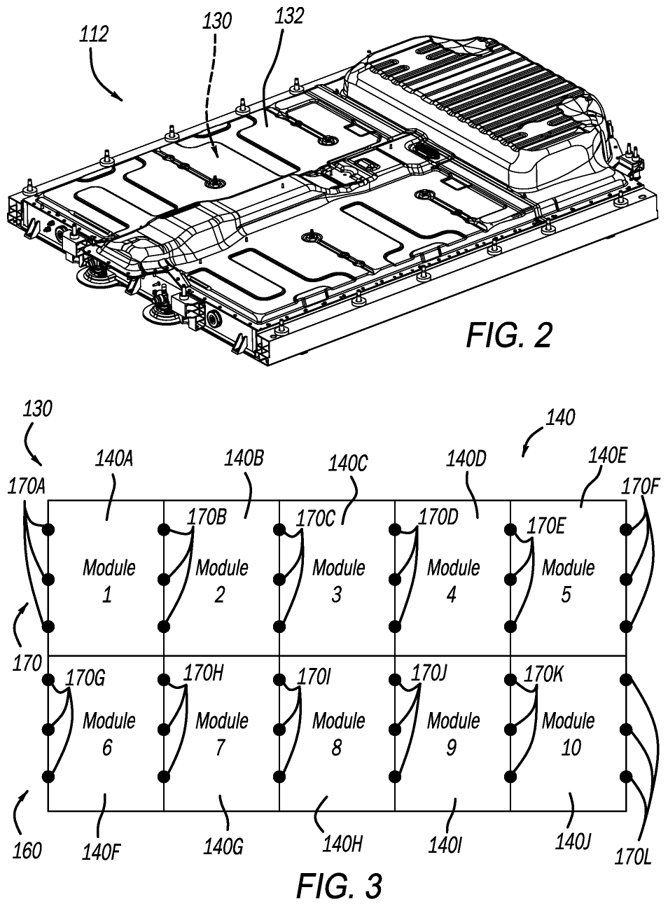

With additional reference now to FIGS. 2-5, additional features of the instant battery pack assembly 130 will be described. In examples, the battery pack assembly 130 can generally include a battery module assembly 140 made up of individual battery modules 140A, 140B, 140C, 140D, 140E, 140F, 140G, 140H, 140I, 140J. The battery system 112 can further include a decoupler 150. As will be described herein, the decoupler 150 can initiate decoupling of an identified battery module from the module assembly 140.

With specific reference now to FIG. 3, the battery pack 130 according to one example of the present disclosure will be further described. The battery pack 130 includes a fastening assembly 160 that couples the individual battery modules 140A-140J to the battery pack 130. The fastening assembly 160 comprises individual fastening sets collectively identified at 170 and individually identified at 170A, 170B, 170C, 170D, 170E, 170F, 170G, 170H, 170I, 170J, 170K and 170L.

As used herein the term “fastener” is used to denote any mechanical coupling means such as nuts, bolts, screws, and the like. It is also contemplated that other coupling methods can be used for fastening the battery modules 140A-140J to the battery pack 130. In examples, chemical or magnetic fasteners can be additionally or alternatively used. In the example shown, each battery module 140A-140J is secured to the battery pack 130 with two adjacent fastening sets. For example, battery module 140C is secured to the battery pack 130 by the fastener sets 170C and 170D. In this regard, in some areas a fastener set 170A-170L can be used to couple more than one battery module 140A-140J to the battery pack 130. In other examples, each fastener set 170A-170L can be configured to be associated with only one battery module 140A-140J. Further, while the example shown illustrates a fastener set as comprising multiple fasteners, in some examples, a fastener set can consist of only a single fastener that couples a respective battery module 140A-140J to the battery pack 130. Other arrangements are contemplated.

The sensors 136 can be configured to sense a thermal event within a particular module 140A, 140B, 140C, 140D, 140E, 140F, 140G, 140H, 140I, 140J. In this regard, while the sensors 136 are generally identified collectively in FIG. 1, the sensors 136 can comprise multiple sensors within the battery pack 130 such as at least one sensor 136 associated with each module 140A-140J. When a thermal event, or the risk of a thermal event, is detected by the sensors 136, the sensors 136 communicate a signal to the controller 142 indicative of the thermal event or risk of a thermal event.

The controller 142, in turn, sends a signal to the fastening sets 170A-170L associated with the faulty battery module 140A-140J. The signal causes the identified fastening sets 170A-170L to decouple the faulty battery module 140A-140J from the remainder of the battery pack 130. Again, more than one battery module 140A-140J can be identified as faulty causing a remedial action (decoupling) to more than one battery module 140A-140J.

In one example, the signal sent by the controller 142 causes the identified fastening sets 170A-170L to fail. In examples, the decoupler 150 can send an electric pulse to heat the identified fastening sets 170A-170L (thereby melting the fasteners or expanding the fasteners such that they fail). In other examples, the fastening sets can be electromagnetic fasteners. The decoupler 150 can send an electromagnetic signal that demagnetizes the fastening sets causing the faulty battery module 140A-140J to separate from the battery pack 130. In other examples, the fasteners can comprise interconnecting fingers and the decoupler 150 can actuate one or more of the interconnecting fingers to move from an interconnected position to a disconnected position allowing the selected battery module 140A-140J to be released from the remainder of the battery pack 130.

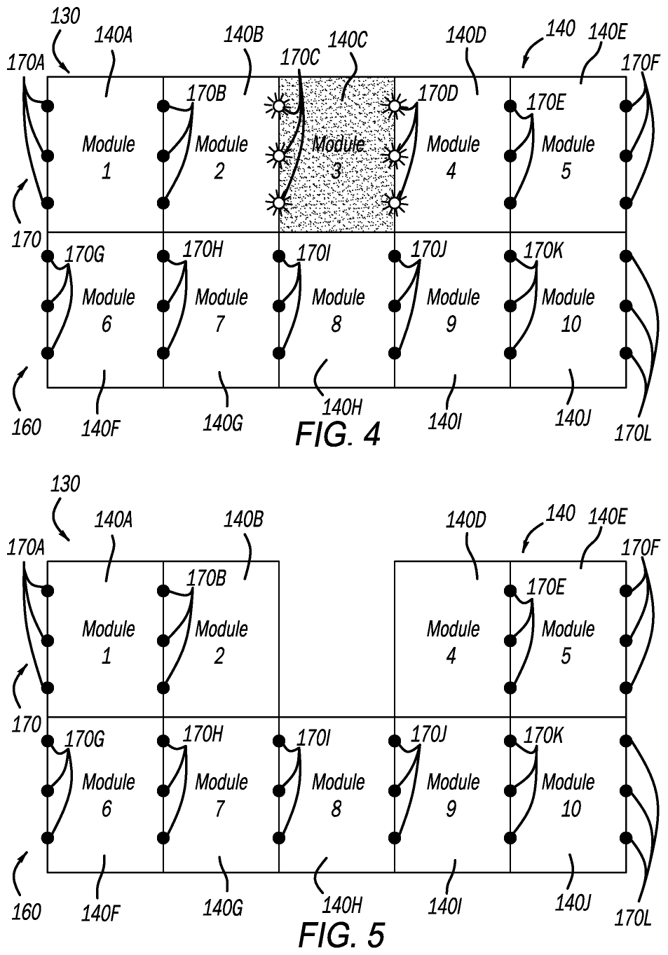

Referring now to FIGS. 4 and 5 an exemplary thermal event is detected by the sensors 136 at the battery module 140C. The sensors 136 communicate a signal to the controller 142. The controller 142, in turn, sends a signal to the fastening sets 170C and 170D associated with the faulty battery module 140C. The signal causes the identified fastening sets 170C and 170D to decouple the faulty battery module 140C from the remainder of the battery pack 130. In one example, the signal sent by the controller 142 causes the identified fastening sets 170C and 170D to fail. Other examples of decoupling the faulty battery module 140C from the remainder of the battery pack 130 described herein may be additionally or alternatively be used.

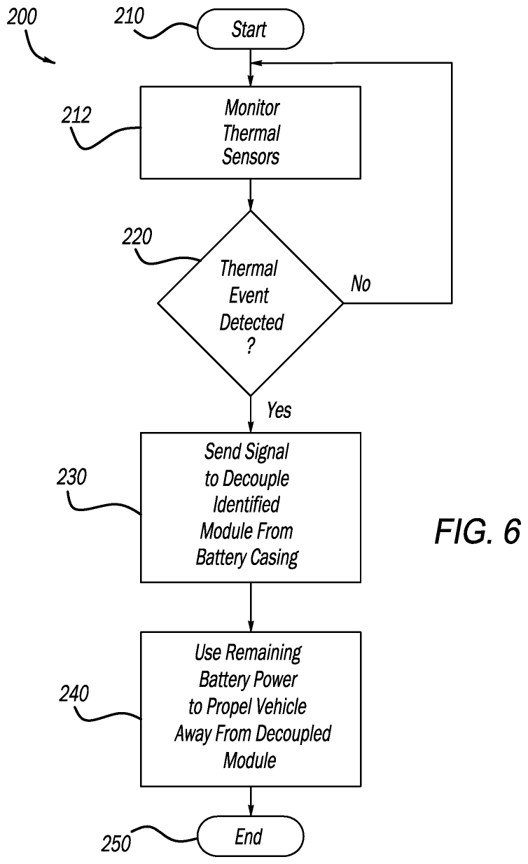

With reference now to FIG. 6 an exemplary method of isolating a faulty battery module to mitigate a thermal runaway event according to one example of the present disclosure is shown an identified at reference numeral 200. The method begins at 210. At 212 control monitors the sensors 136. At 220 control determines whether a thermal event (or the potential of a thermal event) is detected.

If control determines that a thermal event is not detected, control loops to 212. If control determines that a thermal event has been detected, the controller 142 sends a signal to the decoupler 150 to decouple the identified faulty module 140A-140J from the battery casing 132 of battery pack 130. Again, the controller 142 can be configured to send a signal to the decoupler 150 that decouples multiple battery modules (that may be identified as faulty) concurrently or sequentially from the remainder of the battery pack 130. At 240, control uses remaining battery power to propel the vehicle away from the decoupled module.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above.

It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A battery system for an electrified vehicle, the battery system comprising:
a battery pack comprising a battery module assembly having at least a first battery module and a second battery module;
a fastening assembly including a fastening set associated with each battery module of the battery module assembly;
a decoupler configured to initiate decoupling of a selected battery module from the battery pack;
at least one sensor that senses a thermal event at a faulty battery module of the battery module assembly and communicates a thermal event signal in response to the sensing; and
a controller that receives the thermal event signal and responsive to the thermal event signal communicates a decoupling signal to the decoupler to decouple the faulty battery module from the battery pack.

2. The battery system of claim 1, wherein the fastening set associated with each battery module comprises at least one nut and threaded fastener.

3. The battery system of claim 2, wherein the decoupler is configured to send an electric pulse to the fastening set causing the fastening set to fail.

4. The battery system of claim 3, wherein the fastening set comprises a first plurality of fasteners on a first side of the battery module.

5. The battery system of claim 4, wherein the fastening set further comprises a second plurality of fasteners on a second side of the battery module.

6. The battery system of claim 1, wherein the fastening set comprises an electromagnetic fastener and wherein the decoupler sends an electromagnetic signal that demagnetizes the fastening set.

7. The battery system of claim 1, wherein the sensors comprise a sensor associated with each battery module of the battery module assembly.

8. A method of isolating a faulty battery module from a battery pack in an electrified vehicle, the method comprising:
monitoring, at a controller, thermal sensors that sense a thermal event at a faulty battery module of the battery pack;
receiving, at the controller, a thermal signal from the thermal sensors indicative of a thermal event at the faulty battery module; and
sending from the controller, in response to the thermal signal, a decoupling signal to a decoupler that decouples the faulty battery module from the battery pack.

9. The method of claim 8, wherein sending the decoupling signal comprises:
sending a pulse to a fastening set associated with the faulty battery module, the pulse causing the fastening set to fail.

10. The method of claim 9, wherein the fastening set comprises a first plurality of mechanical fasteners on a first side of the faulty battery module.

11. The method of claim 10, wherein the fastening set further comprises a second plurality of mechanical fasteners on a second side of the faulty battery module.

12. The method of claim 9, wherein the fastener set comprises at least one nut and bolt.

13. The method of claim 8, wherein sending the decoupling signal comprises:
sending an electromagnetic signal that demagnetizes the fastening set.

14. The method of claim 8, wherein the battery pack comprises a plurality of battery modules and wherein monitoring thermal sensors that sense a thermal event at a faulty battery module of the battery pack comprises monitoring a thermal sensor associated with each battery module of the plurality of battery modules in the battery pack.
